(19) United States
(12) Patent Application Publication
(10) Pub. No.: US 2026/0268194 A1
(43) Pub. Date: Sep. 10, 2026

(54) PROBABILISTIC ANGLE INTERPOLATION

(71) Applicant: Quantum Motion Technologies Limited, London (GB)

(72) Inventor: Bálint Koczor, London (GB)

(21) Appl. No.: 19/480,022

(22) PCT Filed: May 17, 2024
(86) PCT No.: PCT/EP2024/063725

§ 371 Date: Oct. 29, 2025

(30) Foreign Application Priority Data
May 24, 2023 (EP) 23175002.7

(51) Int. Cl. G06N 10/40

(52) U.S. Cl. CPC G06N 10/40

(57) ABSTRACT

A method of implementing a rotation gate having a selectable rotation angle using a quantum device with discretised gates each having a discrete gate angle setting, the method comprising: (i) receiving an instruction to apply a rotation gate having a selected rotation angle; (ii) determining at least three discretised gates, based on the selected rotation angle, each having different discrete gate angle settings; (iii) determining a relative frequency; (iv) selecting one of the determined discretised gates based on the determined relative frequency; (v) applying the selected discretised gate to a qubit; (vi) measuring the state of the qubit to provide an output; (vii) repeating steps (iv)-(vi) a plurality of times; and (viii) combining the outputs from step (vi) to obtain a combined output based on the selected discretised gates.

### FIELD OF THE INVENTION

The present invention relates to quantum computing.

### BACKGROUND

In a quantum algorithm, quantum gates are applied to qubits. It is typically desirable to be able to implement a continuous set of parametrised gates. Parametrised Pauli gates are a set of gates that are suitable. These gates encompass most gatesets developed for quantum technologies, including single qubit X, Y or Z rotations or two-qubit XX entangling gates.

Parametrised Pauli gates are associated with a particular angle of rotation and may be referred to as a rotation gate. When a rotation gate is applied to a qubit, the state of the qubit is rotated around an axis of the Bloch sphere by the angle of rotation.

Measurement of the state of a device's qubits following application of an appropriate sequence of rotation gates provides a binary output which, when averaged over many repetitions, provides an estimate of the expected value of an observable of the system.

The desired angle of rotation of the gate is based on experimental requirements. However, in practice it is not always possible to apply a gate having the desired angle of rotation, because the classical control infrastructure requires the discretisation of the gate angles. One highly relevant class of hardware is that of electron spin qubits within a semiconductor device; here, gates are typically implemented with the aid of electrical potentials applied via electrodes—in an efficiently scalable machine, it is highly desirable to limit the number of distinct control fields required, and consequently the number of possible gate rotations is limited. Nevertheless, for universal quantum computing it must be possible to realise arbitrary gate rotations as desired for any given algorithm.

One solution is to apply a rotation gate having a rotation angle which is nearest to the desired rotation angle. However, this introduces a discrepancy whenever the desired rotation angle does not match the available rotation angle, because the applied rotation gate is different from the desired rotation gate.

In order to reduce the effect of the difference between the desired and available angles of rotation, a quantum device having a large number of available rotation angles can be used. In this way, an available rotation angle which is closer to the desired rotation angle can be chosen. However, a disadvantage of this solution is that the control circuitry required is extensive and complex which leads to greater fabrication costs of the device. Furthermore, this solution does not eliminate the discrepancy between the desired and available angles of rotation. Still further, the power consumption of a quantum device having a large number of available rotation angles can be relatively high, which is not preferred particularly when operating at low temperatures such as the cryogenic temperatures used in solid-state technologies.

An alternative solution is to apply a sequence of gates in place of a single gate. A discrete set of parametrised Pauli gates having different angles of rotation can be used to construct a continuously parametrised gate with only a logarithmic overhead. However, a disadvantage of this solution is the increased circuit depth required to implement a specific rotation gate.

It is desirable to implement a rotation gate having the desired rotation angle without requiring a deep circuit or complex hardware.

### SUMMARY OF INVENTION

An aspect of the invention provides a method of implementing a rotation gate having a selectable rotation angle using a quantum device with discretised gates each having a discrete gate angle setting. The method comprises: (i) receiving an instruction to apply a rotation gate having a selected rotation angle, wherein the selected rotation angle is not the same as any of the discrete gate angle settings; (ii) determining at least three discretised gates, based on the selected rotation angle, each having different discrete gate angle settings, wherein: a first discrete gate angle setting is less than the selected rotation angle; a second discrete gate angle setting is greater than the selected rotation angle; and a third discrete gate angle setting differs by more than an angle of π/2 with respect to the selected rotation angle; and (iii) determining a relative frequency for selecting each of the at least three determined discretised gates. The method further comprises (iv) selecting one of the at least three determined discretised gates based on the determined relative frequency; (v) applying the selected discretised gate to a qubit; and (vi) measuring the state of the qubit to provide an output. The method further comprises (vii) repeating steps (iv)-(vi) a plurality of times; and (viii) combining the outputs from step (vi) to obtain a combined output based on the selected discretised gates.

An advantage of this method is that a continuous rotation gate can be implemented using a shallow circuit and a low complexity quantum device with low power consumption. The circuit is shallow because a step of applying the rotation gate having the selected rotation angle to the qubit is replaced with, not added to, by the application of one of the determined discretised gates per circuit repetition. Discretisation of the rotation angles of the quantum gates advantageously reduces the complexity of the device which reduces fabrication cost and provides lower power consumption. Determining a relative frequency for selecting each of the at least three determined discretised gates and applying each of the discretised gates accordingly advantageously enables a combined output to be obtained which corresponds to the average output for the rotation gate having the selected rotation angle.

Various hardware platforms in which the method can be employed, including semiconductor electron spin devices, typically require low temperatures, such as cryogenic temperatures of 4 Kelvin or lower, and therefore low power consumption is an important benefit.

The terms “gate”, or “rotation gate” may also be referred to as a rotation, a gate operation, or a rotation operation. These terms typically mean the super-operator representation of a parametrised Pauli gate, i.e. [symbol] (θ)=exp(−i P θ) which is defined as an exponential of any Pauli operation P. For single-qubit Pauli X, Y and Z operations this angle represents a rotation of θ of the Bloch sphere around the X, Y or Z axes, respectively. The Bloch sphere is a geometrical representation of the pure state space of a two-level quantum mechanical system, and rotations around the Bloch sphere represent the evolution of the state of a qubit. The surface of the sphere represents pure quantum states and the inner region of the sphere represents mixed quantum states.

The selectable rotation angle is preferably a rotation angle that may be selected from any rotation angle around the Bloch sphere. Optionally, the selectable rotation angle is a rotation angle that may be selected from one or more portions of the Bloch sphere. Optionally, the selectable rotation angle may be selected with finite precision.

The quantum device has discretised gates and each discretised gate has a discrete gate angle setting. The quantum device with discretised gates may be a quantum device configured to perform a set of discretised gates each having different discrete gate angle settings. Many types of quantum device must, in practice, have discretised gates because it is not possible to realise a continuous set of gates without utilising considerable additional quantum resources. Each gate corresponds to a particular rotation around an axis of the Bloch sphere. The rotation angle associated with a particular discretised gate is fixed.

The relative frequency is preferably determined to enable the combined output to correspond to the average output for the rotation gate having the selected rotation angle.

Once at least three discretised gates have been determined based on the selected rotation angle and the relative frequency for selecting these gates has been determined, one of the at least three determined discretised gates is selected. The selection is performed based on the determined relative frequency; however the order in which the discretised gates are applied over the course of successive repetitions is not important and does not affect the combined output.

For each repetition, the selected discretised gate is applied to a qubit. The qubit is typically initialised prior to the application of the discretised gate. For each repetition, the qubit may be the same qubit, or may be a different qubit.

Typically, a quantum algorithm requires a circuit having a plurality of parametrised gates. Preferably, when a circuit having a plurality of parametrised gates is run, the above method is applied to each quantum gate individually. Preferably, a method of implementing first and second rotation gates having first and second selectable rotation angles using a quantum device with discretised gates each having a discrete gate angle setting is provided, the method comprising: (i) receiving an instruction to apply first and second rotation gates having first and second selected rotation angles respectively, wherein the first and second selected rotation angles are not the same as any of the discrete gate angle settings; (ii)(a) determining a first set of at least three discretised gates, based on the first selected rotation angle, each having different discrete gate angle settings, wherein: a first first discrete gate angle setting is less than the first selected rotation angle; a first second discrete gate angle setting is greater than the first selected rotation angle; and a first third discrete gate angle setting differs by more than an angle of π/2 with respect to the first selected rotation angle; (ii)(b) determining a second set of at least three discretised gates, based on the second selected rotation angle, each having different discrete gate angle settings, wherein the first set and second set of at least three discretised gates may comprise one or more of the same discretised gates, wherein a second first discrete gate angle setting is less than the second selected rotation angle; a second second discrete gate angle setting is greater than the second selected rotation angle; and a second third discrete gate angle setting differs by more than an angle of π/2 with respect to the second selected rotation angle; (iii)(a) determining a first relative frequency for selecting each of the at least three determined discretised gates in the first set; (iii)(b) determining a second relative frequency for selecting each of the at least three determined discretised gates in the second set; (iv)(a) selecting one of the at least three determined discretised gates from the first set as a first selected discretised gate based on the first determined relative frequency; (iv)(b) selecting one of the at least three determined discretised gates from the second set as a second selected discretised gate based on the second determined relative frequency; (v) applying the first and second selected discretised gates to a qubit; (vi) measuring the state of the qubit to provide an output; (vii) repeating steps (iv)-(vi) a plurality of times; and (viii) combining the outputs from step (vi) to obtain a combined output based on the selected discretised gates.

Optionally, the first and second rotation angles are different from each other. However, the first and second rotation angles may be the same. When the first and second rotation angles are the same, the first and second sets are the same, and the first and second relative frequencies are the same.

Advantageously, this method implements a sequence of rotation gates having selectable rotation angles using a shallow circuit and low complexity quantum device with low power consumption. The measurement overhead typically scales with the number of quantum rotation gates v in a worst-case scenario as e^{vΔ}^{²}^{/4}, wherein Δ is the separation between discrete gate angle settings in the quantum device. Advantageously this is a very small overhead, even when the quantum device has very few discretised gates, for example the quantum device may have fewer than 10 gates.

Typically, the method comprises received an instruction to apply a sequence of N rotation gates, wherein N>2, each of the N rotation gates having a selected rotation angle which may be the same or different. Preferably, N sets of at least three discretised gates are determined based on the selected rotation angle for each of the N rotation gates. Two or more of the N sets may be the same. Preferably, N relative frequencies are determined for selecting each of the at least three determined discretised gates in each of the N sets. Preferably, one of the at least three determined discretised gates from each of the N sets is selected based on the corresponding determined relative frequency, thereby resulting in N selected discretised gates. Preferably the N selected discretised gates are applied to a qubit in sequence. Preferably, the step of measuring the state of the qubit to provide an output is performed after the N selected discretised gates have been applied. Preferably, the steps of selecting of N discretised gates, applying said gates in sequence, and measuring the state of the qubit to provide an output are performed a plurality of times. Preferably, the outputs from the measurements are combined based on the selected discretised gates to obtain a combined output.

When a plurality of discretised gates is applied to a qubit in step (v), the qubit is typically initialised prior to the application of the first discretised gate of the sequence for each repetition.

Optionally, the to-be-executed circuit may include thousands of parametrised gates, for example up to 10,000 parametrised gates. Optionally, the circuit may include non-parametrised gates in addition to parametrised gates. These non-parametrised gates can either be chosen from a distinct family of gates, e.g., CNOT gates, or chosen to be one of the discretised rotation gates such that the desired rotation angle matches one of the discrete angles, e.g., a Pauli X bitflip. Such non-parametrised gates do not introduce any measurement overhead and can be implemented directly without using the described method. Optionally, one or more quantum operations can be performed between step (v) and step (vi).

The discretised gates may be applied to one qubit, or to two qubits. Advantageously this increases the flexibility of the quantum device to execute different quantum algorithms including single-qubit and two-qubit quantum gates.

For each repetition, the state of the qubit is eventually measured following the application of the selected discretised gate or gates to the qubit. Optionally, this is performed using a measurement device or a readout device. The output from the measurement is typically binary, i.e. leaving the qubit in either the state |0 [symbol] or |1 [symbol] , and the outcome can be recorded by correspondingly noting one of two values such as “+1” and “−1” respectively.

The steps of selecting a gate or gates, applying said gate(s) to a qubit, and measuring of the state of said qubit, are performed a plurality of times. For each repetition, a plurality of quantum operations is typically performed before measuring the qubit state. Preferably, these steps are repeated at least 100 times, although in some applications fewer repetitions may be acceptable. Following the plurality of repetitions, the measurements of “0” or “1” are combined to obtain a combined output. The combined output is preferably determined by multiplying each measurement output by +1 or −1 according to the selected discretised gate or gates; adding the outputs together; and scaling the sum according to the total number of measurements and a global pre-factor, or norm. The number of measurements typically scales according to the number of repetitions.

The combined output typically corresponds to an average output for the rotation gate having the selected rotation angle. Typically, if the quantum device was configured to perform the rotation gate, the average output for the rotation gate would be obtained by applying the rotation gate having the selected rotation angle to a qubit; measuring the state of the qubit to provide an output (which is binary); and repeating these steps a plurality of times. It is noted that the average output is a theoretical construct as it is not possible to apply the rotation gate having a selected rotation angle using a quantum device with discretised gates and in relevant hardware realisations it is not possible to have a physical quantum device with continuously parametrised gates. Therefore, the average output is preferably the theoretical average output that would be obtained were it possible to apply the rotation gate having the selected rotation angle. An advantage of the method is that a physical quantum device, having discretised gates, effectively has the capability to implement continuously parametrised gates.

Preferably, the selection in step (iv) is performed randomly based on the determined relative frequency. For example, step (iii) may comprise determining a probability for selecting each of the at least three determined discretised gates and step (iv) may comprise selecting one of the at least three determined discretised gates based on the determined probability.

Random selection in this way requires less hardware to implement and therefore advantageously simplifies the control infrastructure. Alternatively, it is possible to determine an order in which to perform the at least three determined discretised gates and to select one of the at least three determined discretised gates based on the determined relative frequency and the determined order.

Preferably, step (iii) comprises: expressing the rotation gate as a linear combination of the determined discretised gates from step (ii); and determining a coefficient for each of the determined discretised gates in the linear combination, wherein the coefficient for one of the determined discretised gates is negative. Preferably, when three discretised gates are determined, only one coefficient is negative. If more than three discretised gates are determined, one or more, but not all, coefficients may be negative.

Advantageously, the expression can be used to determine the relative frequency for selecting each of the three determined discretised gates.

Furthermore, the signs of the coefficient can advantageously be used to determine how to combine the measurements in step (viii). Preferably, when the selected discretised gate has a positive coefficient in the expression, the output from the measurement of the state of the qubit when that gate is applied is multiplied by +1. Preferably, when the selected discretised gate has a negative coefficient in the expression, the output from the measurement of the state of the qubit when that gate is applied is multiplied by −1. Therefore, when the coefficient is positive and the measurement output was recorded as “+1” then indeed its contribution to the total is +1, and when the coefficient is negative and the measurement output was recorded as “+1” then its contribution to the total will be negative, i.e. −1. The converse applies if the recorded measurement was “−1”. The combination of negative and positive outputs advantageously replicates a pure quantum state.

Preferably, when a plurality of discretised gates is applied to the qubit, each measurement output is recorded alongside the sequence of selected discretised gates applied to the qubit before the measurement. Typically, when the selected discretised gates for a particular iteration of steps (iv)-(vi) includes an odd number of selected discretised gates having a negative coefficient in the expression, the output from the measurement of the state of the qubit is multiplied by −1. Typically, when the selected discretised gates for a particular iteration of steps (iv)-(vi) includes an even number of selected discretised gates having a negative coefficient in the expression, the output from the measurement of the state of the qubit is multiplied by +1.

A first discrete gate angle setting is less than the selected rotation angle and a second discrete gate angle setting is greater than the selected rotation angle. The first and second discrete gate angle settings correspond to first and second discretised gates determined in step (ii).

Advantageously, this enables a proportion of under-rotated gates and a proportion of over-rotated gates to be applied to a qubit.

Preferably, the first and second discrete gate angle settings are the closest two discrete gate angle settings to the selected rotation angle.

Advantageously, this provides an efficient manner in which to apply a proportion of under- and over-rotated gates to a qubit. Furthermore, by selecting the closest discrete gate angle settings, the measurement overhead is reduced in comparison with selecting discrete gate angle settings further from the selected rotation angle.

A third discrete gate angle setting differs by more than an angle of π/2 with respect to the selected rotation angle. The third discrete gate angle setting corresponds to a third discretised gate determined in step (ii). This means that the third discrete gate angle setting is preferably substantially antipolar to the selected rotation angle. This advantageously reduces the variance of the combined output obtained in step (viii).

Preferably, when the rotation gate is expressed as a linear combination of the determined discretised gates, the third discretised gate having a discrete gate angle setting that is close to antipolar, i.e. π (pi) radians or 180 degrees, from the selected rotation angle has a negative coefficient. Preferably, when the third discretised gate is applied to a qubit, the sign of the output is flipped. Flipping the sign of the output means multiplying the output by −1. This advantageously serves to restore a pure quantum state.

Preferably, when the rotation gate is expressed as a linear combination of determined discretised gates, the sign of the output is flipped when a gate having a negative coefficient is applied to a qubit.

Preferably, first, second and third discretised gates are determined having first, second and third discrete gate angle settings respectively. The first and second discrete gate angle settings may be the closest discrete gate angle settings to the selected rotation angle, and the third discrete gate angle setting may be antipolar i.e. approximately pi radians away from the selected rotation angle.

Advantageously, the use of these three discretised gates provides the most efficient combination of gates, requiring a small overhead and providing a combined output having a low variance.

Optionally, additional discretised gates are determined having additional, different, discrete gate angle settings. Preferably, in this case, at least two of the determined discretised gates are within ±π/2 radians of the selected rotation angle and at least one of the determined discretised gates is more than π/2 radians from the selected rotation angle. Preferably, the outputs measured when the determined discretised gates within π/2 radians of the selected rotation are applied to a qubit are multiplied by ±1, and the outputs measured when the determined discretised gates further than π/2 radians from the selected rotation are applied to a qubit are multiplied by −1.

Preferably, the difference between two of the discrete gate angle settings is approximately π. Advantageously, this ensures two of the discrete gate angle settings are on opposite sides of the unit circle which acts to recover the pure, or ideal, quantum state. Typically, at least two discretised gates are within π/2 radians of the selected rotation angle, for example they may be the two nearest gate angle settings. Use of these discretised gates without a gate angle setting on the opposite side of the unit circle may result in a mixed combined output, i.e. a qubit state lying inside the Bloch sphere. Applying two discretised gates having an angular difference of π, or approximately π, serves to recover the ideal quantum state for the combined output. This may be achieved by changing the sign of the output when the applied rotation angle of the selected discretised gate is antipolar to the selected rotation angle. Optionally, in the event that a discretised gate having a difference in rotation angle of IT is not available in the quantum device, the difference between two of the discrete gate angle settings may be between

$$\frac{π}{2} and \frac{3 π}{2} .$$

Optionally, the discrete gate angle settings are evenly distributed in the range 0 to 2π. Alternatively, the discrete gate angle settings are unevenly distributed around the range 0 to 2π. That is, the angular separation between adjacent discrete gate angle settings may be constant or otherwise. This may be adapted based on experimental requirements. For example, in the event that the rotation gates to be implemented using the quantum device have a wide and relatively even angular spread, it is preferred that the angular separation between adjacent discrete gate angle settings is substantially similar. Alternatively, in the event that the rotation gates to be implemented using the quantum device are unevenly spread, for example focussed around particular angular regions, it is preferred that the angular separation between adjacent discrete gate angle settings is similarly uneven. For example, the discrete gate angle settings may be concentrated in regions in which the rotation angles of the to-be-implemented rotation gates are present. Advantageously, a quantum device having discretised gates with evenly spread discrete gate angle settings can be used to implementing a variety of rotation gates in an efficient manner.

Preferably, the repetition step (vii) is performed between 10² and 10⁸ times, preferably between 10⁵ and 10⁶ times. The output from each measurement in step (vi) is binary, and therefore repeating the measurement more times can advantageously improve the precision of the combined output. In some cases, due to hardware constraints, each selected discretised gate may be applied a plurality of times. Optionally, when N parametrised gates are implemented in sequence, M distinct sequences of N selected discretised gates may be determined and each of the M sequences may be applied a plurality of times. This advantageously may be more computationally efficient than determining a different sequence for each repetition. The measurement overhead is negligible and therefore an advantage of the method is that the additional resource cost for implementing the method is negligible.

Preferably, step (ii) comprises determining three discretised gates, based on the selected rotation angle, each having different discrete gate angle settings. Three or more discretised gates may be determined, however determining only three discretised gates advantageously increases the efficiency of the method.

Optionally, step (ii) comprises searching a data set for the selected rotation angle, wherein the data set comprises selectable rotation angles and at least three corresponding discretised gates for each selectable rotation angle; and determining at least three discretised gates based on the at least three discretised gates in the data set corresponding to the selected rotation angle.

Advantageously, looking up the appropriate discretised gates in a data set is an efficient way in which to determine the at least three discretised gates to apply.

Optionally, the data set further comprises relative frequencies for selecting each of the at least three discretised gates corresponding to each selectable rotation angle, and wherein step (iii) comprises: searching the data set for the selected rotation angle; and determining a relative frequency for selecting each of the at least three determined discretised gates based on the relative frequency in the data set corresponding to the selected rotation angle. Advantageously, looking up the relevant relative frequencies in a data set is efficient.

Optionally, the data set may be populated following the determining steps (ii) and/or (iii) each time the at least three discretised gates and the relative frequency are determined for a particular selected rotation angle. Optionally, after step (ii), the determined at least three discretised gates are stored in the data set. Optionally, after step (iii), the determined relative frequencies corresponding to the at least three discretised gates are stored in the data set. Advantageously, when an instruction is received to apply a rotation gate which has previously been applied, the determining steps can be simplified because the previously-determined values can be re-used.

Preferably, steps (ii)-(iv) are computed prior to applying the selected gate or gates in step (v). Optionally, steps (ii)-(iv) are computed for each of the plurality of repetitions prior to the first application of the selected gate or gates. Advantageously, this reduces the running time of the quantum algorithm.

Preferably, the at least three determined discretised gates are determined from a set of between 3 and 2¹⁸ discretised gates, preferably between 2¹² discretised gates, more preferably between 3 and 128 discretised gates. Advantageously, a smaller set of discretised gates, comprising fewer available discretised gates to determine a subset of at least three from, requires less classical control infrastructure which requires less power to run and occupies less space on a physical device. Furthermore, discretising the quantum gates advantageously reduces the complexity of engineering a precisely controlled quantum device. Providing fewer discretised gates, i.e. fewer bits, further reduces the power consumption of the quantum device. Advantageously, increasing the number of discretised gates decreases the variance of the combined output. The advantages of increasing and decreasing the number of discretised gates are preferably balanced. The increased variance is usually small and therefore it is typically more advantageous to decrease the number of discretised gates. However, a minimum number of discretised gates is required in order to perform the method.

Typically, the method steps are performed using either the quantum device or a classical controller. Typically, the quantum device is configured to perform steps (v), (vi) and (vii) of the method, and the classical controller is configured to perform steps (i), (ii), (iii), (iv) and (viii) of the method.

Typically, the combined output corresponds to an expected value of an observable property of the system. Accordingly, the method can beneficially be used to measure the expected value of an observable property of the system by selecting a particular rotation angle corresponding to the observable.

Typically, a quantum algorithm is performed using a plurality of qubits. For example, the method may comprise receiving instructions to apply rotation gates to each qubit in the plurality of qubits. The rotation gates applied to different qubits may be the same or may be different, i.e. may have the same angular rotation or different angular rotations. A plurality of rotation gates may be applied to each qubit. Preferably, the method is applied to each qubit individually, in that the performance of steps (ii)-(viii) of the method in relation to a first qubit would not impact the performance of steps (ii)-(viii) of the method in relation to a second qubit different from the first qubit.

Another aspect of the invention provides a quantum device with discretised gates each having a discrete gate angle setting. The quantum device is configured to perform the method according to the first aspect.

An advantage of the quantum device according to this aspect is that its power consumption is low due to the discretisation of the gates. This has a further advantage that the device is suitable for use at cryogenic temperatures due to the low power consumption.

Optionally, the device is a semiconductor device comprising quantum dots configured to electrostatically trap electron spins. Advantageously, such a device is particularly suitable for implementing the method.

Optionally, the discretised gates are determined by a discrete set of possible voltage settings. Advantageously, this control mechanism is straightforward to implement.

Preferably, the quantum device has between 3 and 2¹⁸ discretised gates, more preferably between 3 and 2¹² discretised gates, even more preferably between 3 and 2⁷=128 discretised gates. Advantageously, a quantum device having fewer discretised gates consumes less power and occupies less space due to the reduced classical control infrastructure requirements.

Typically, the quantum device is silicon-based, and may be manufactured using complementary-metal-oxide-semiconductor manufacturing processes.

An aspect of the invention provides a method of implementing a rotation gate having a selectable rotation angle using a quantum device with discretised gates each having a discrete gate angle setting. The method comprises: (i) receiving an instruction to apply a rotation gate having a selected rotation angle, wherein the rotation angle is not the same as any of the discrete gate angle settings; (ii) determining at least three discretised gates, based on the selected rotation angle, each having different discrete gate angle settings; and (iii) determining a relative frequency for selecting each of the at least three determined discretised gates. The method further comprises (iv) selecting one of the at least three determined discretised gates based on the determined relative frequency; (v) applying the selected discretised gate to a qubit; and (vi) measuring the state of the qubit to provide an output. The method further comprises (vii) repeating steps (iv)-(vi) a plurality of times; and (viii) combining the outputs from step (vi) to obtain a combined output based on the selected discretised gates.

### BRIEF DESCRIPTION OF DRAWINGS

Embodiments of the invention will now be described with reference to the accompanying drawings in which:

FIG. 1A is a schematic illustration of a method of implementing a rotation gate;

FIG. 1B is a schematic illustration of a method of implementing a rotation gate in accordance with an embodiment of the invention;

FIG. 2 is a graph illustrating probability distributions;

FIG. 3 is a graph illustrating gradient descent minimisation; and

FIG. 4 is a schematic illustration of the gate angle settings.

### DETAILED DESCRIPTION

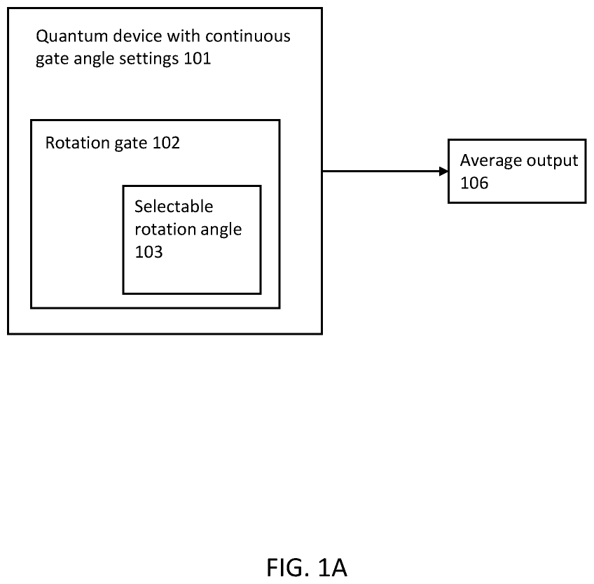

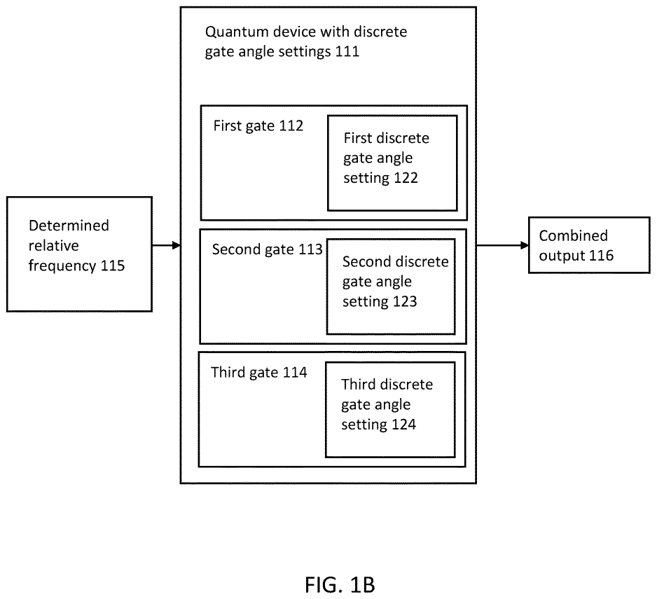

The ability to realise a continuous set of parametrised gates is required by many near-term quantum algorithms. A particularly useful set of gates are so-called parametrised Pauli gates, which are suitable for representing physical platforms. FIG. 1A schematically illustrates a theoretical quantum device with continuous gate angle settings 101. Such a device could be used to apply a rotation gate 102 having a selectable rotation angle 103. The rotation angle 103 is a continuous angle setting in FIG. 1A. This means that the selectable rotation angle 103 in this example is any specified rotation around a rotation axis of the Bloch sphere, such as the X, Y or Z axis. In this theoretical quantum device with continuous gate angle settings 101, there is no limitation on the precision of the selectable rotation angle, due to the continuous nature of the gate angle settings. In an alternative example, the selectable rotation angle may be selectable from one or more separate angular regions.

Following the application of the rotation gate 102 having the selected rotation angle 103 to a qubit, measurement of the state of the qubit would return a binary output, i.e. the qubit will be in state |0> or |1> which may be stored for subsequent processing by recording “+1” or “−1” respectively. An average output 106 would be obtained by calculating a scaled mean value of the measurements. For example, if the aim is to estimate the expected value of the Pauli Z operator of the qubit, then if 400 of 1000 measurements were recorded as “−1” and 600 of 1000 measurements were recorded as “+1”, the average output 106 would be ((400 x−1)+ (600×1))/1000=0.2. This provides the expected value of an observable of the quantum system. Instead of assigning numbers to the outcomes |0> and |1>, one might assign other mathematical objects to the individual outputs, such as probability distributions, matrices, or so-called classical snapshots, which are then similarly averaged over.

However, in quantum computing technologies, gate instructions (for example to perform a specific rotation gate) need to be scheduled by classical control infrastructure. A user needs to specify what kind of gate they want to implement and to which qubits in the system. Classical control infrastructure is typically digital, and therefore the gate angles need to be discretised into B bits. That is to say that although it is desirable to implement rotation gates having a gate angle setting selected from a continuous angular range, in many hardware realisations is not possible in practice to do this by providing a quantum device with continuous gate angle settings 101.

Embodiments of the invention enable rotation gates 102 having a selectable rotation angle 103 to be implemented using a quantum device with discretised gates as shown in FIG. 1B. In FIG. 1B, the quantum device with discrete gate angle settings 111 has first, second and third gates 112, 113, 114 that have been determined from a set of ten discretised gates. Each determined discretised gate 112-114 has a respective discrete gate angle setting 122, 123, 124, as shown in FIG. 1B. The quantum device with discrete gate angle settings 111 can, using the method described herein, implement a rotation gate 102 having a selectable rotation angle 103 as shown in FIG. 1A.

The first, second and third discrete gate angle settings 122-124 are three different angles. The remaining discretised gates (not shown) have discrete gate angle settings different from each other and different from the first, second and third discrete gate angle settings. In this example, the quantum device has three determined discretised gates 112-114, determined from a set of ten discretised gates. However, in other examples, the quantum device with discrete gate angle settings 111 may have more determined discretised gates, and/or the set of discretised gates may be larger or smaller. Each gate is a rotation gate which corresponds to a particular angular rotation.

In the method, a determined relative frequency 115 is used to select one of the determined discretised gates 112-114. The determined relative frequency 115 may, for example, be 50:49:1. This relative frequency indicates that for every 100 repetitions, the first gate 112 should be applied 50 times, the second gate 113 should be applied 49 times and the third gate 114 should be applied once. The order in which the discretised gates 112-114 are applied is not thought to be important. In this example, the discretised gates 112-114 are selected randomly. The control infrastructure is randomly instructed to apply one of the determined discretised gates 112-114. Alternatively, the discretised gates 112-114 may be selected in an ordered manner such as in blocks of the same gate, alternating between the determined gates, or another pre-determined sequence.

Following the application of the first, second or third gate 112-114 having the first, second or third gate angle setting 122-124 respectively to a qubit, measurement of the state of the qubit would return a binary output, i.e. the qubit will be in state |0> or |1> and a classical memory will record a “+1” or “−1” respectively. A combined output 116 is obtained by adding the outputs, each output multiplied by +1 or −1 based on the selected discretised gates, and scaling the sum according to the total number of measurements and a global pre-factor. In this example, the applied discretised gate is stored together with the output for each repetition in order to determine a multiplicative factor for each output, i.e. +1 or −1. In an example in which a sequence of a plurality of discretised gates is applied for each repetition, the sequence of applied discretised gates is stored together with the output for each repetition in order to determine a multiplicative factor for each output.

The combined output 116 obtained using the quantum device with discrete gate angle settings 111 corresponds to the theoretical average output 106 that would be obtained using the theoretical quantum device with continuous gate angle settings 101.

The method described can be used when the chosen rotation angle 103 is not the same as any of the available angles 122-124 in the device with discrete gate angle settings 111. In the event that the chosen rotation angle 103 is equal to one of the discrete gate angle settings 122-124, the quantum device with discrete gate angle settings 111 would simply be used to apply the relevant discretised gate 100% of the time, for each repetition. Subsequently, the outputs from the measurements would be combined by averaging the measurements and multiplying the average by a factor, i.e. determining a scaled mean.

When an instruction to apply a rotation gate 102 having a selected rotation angle 103 is received, if the rotation angle 103 is not the same as any of the discrete angle settings 122-124, at least three discretised gates 112-114 are determined based on the selected rotation angle 103. The three discretised gates 112-114 each have different discrete gate angle settings 122-124. A relative frequency 115 is determined for selecting each of the at least three determined discretised gates 112-114. Subsequently, the first, second, or third discretised gate 112-114 selected based on the determined relative frequency 115 and the selected gate 112-114 is applied to a qubit. The state of the qubit after each discretised rotation gate 112-114 has been applied is ultimately measured in order to provide an output from each measurement which is binary. Therefore, the method enables an instruction to a quantum device to be converted into randomised instructions for a device that can only perform quantum gates having a discrete set of rotation angles such that the combined output 116 is the same as the theoretical average output 106.

In this example, the selection of one of the determined discretised gates 112-114 is a random choice. However, due to the determined relative frequency, the exact, desired unitary rotation gate 102 having the selected rotation angle 103 is performed on average.

In this example, an increased number of circuit repetitions is used to obtain a combined output, i.e. to measure an expected value of an observable. However, the measurement overhead resulting from the additional circuit repetitions is negligible. For example, for a circuit with 1000 parametrised gates and a discretisation of B=7 bits of resolution (i.e. the quantum device has 2⁷=128 discretised gates from which to determine at least three discretised gates for implementing the rotation gate having the selectable rotation angle), the measurement overhead in the worst case is approximately a factor of 2. It is noted that apart from a slightly increased number of circuit repetitions, an advantage of the described method is that no additional quantum resources are required.

In another example, an instruction to apply first and second rotation gates having first and second selected rotation angles is received. The first and second rotation angles are not the same as any of the discrete angle settings. A first set of at least three discretised gates is determined based on the first selected rotation angle. The first set includes first, second and third discretised gates. A second set of at least three discretised gates is determined based on the second selected rotation angle. The second set includes the second discretised gate and fourth and fifth discretised gates. First and second relative frequencies are determined for selecting each of the determined discretised gates in the first and second sets respectively. The state of the qubit after each sequence of discretised rotation gates has been applied is measured in order to provide an output. Each sequence of applied rotation gates includes one discretised gate from the first set and one discretised gate from the second set.

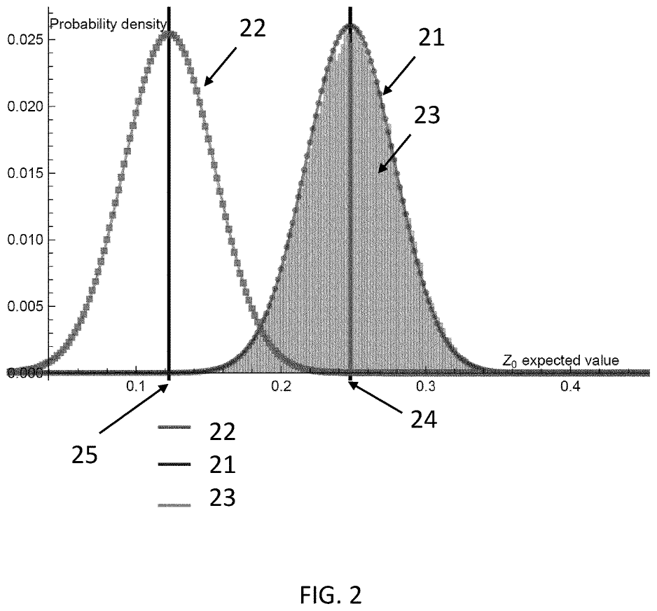

FIG. 2 illustrates the average output for a rotation gate having a selected rotation angle, the corresponding combined output using the method described in relation to FIGS. 1A and 1B, and the average output for a comparative example. FIG. 2 shows the probability distributions for the three scenarios described. Each scenario is based on estimating the expected value of the Pauli operator [symbol] Z₀ [symbol] in a 6-qubit circuit with v=120 parametrised gates and 1000 repetitions, or “shots”. The Pauli operator Z on qubit 0, i.e. [symbol] Z₀ [symbol] is estimated by running the 6-qubit circuit and applying a measurement to qubit 0. When this measurement yields the outcome |1>, a number is assigned to the outcome as follows: <1|Z|1>=−1 and when the measurement yields |0> a number is assigned to the outcome as follows: <0|Z|0>=+1. Subsequently, these individual outcomes are multiplied by a sign, +1 or −1, that is determined based on which selected discretised gate or gates were applied in the quantum circuit. Finally, the mean of the individual outcomes is computed and multiplied by a global pre-factor ∥g∥. The root mean square (RMS) deviation decreases as the number of shots is increased.

The first probability distribution 21 is theoretically determined based on a theoretical quantum device that has infinite resolution and can therefore perform a gate with any rotation angle on a continuous spectrum. As described above, such a device cannot be realised in many hardware realisations; however the theoretical predictions can be used to determine the efficacy of a physical quantum device. The scaled mean value 24 of the first probability distribution 21, the expected value [symbol] Z [symbol] , is approximately 0.25.

The second probability distribution 22 is theoretically determined based on a quantum device that can only perform rotations with seven bits of precision. This means that the quantum device has 2⁷ discretised gates, each having a different discrete gate angle setting. In this example, when an instruction is received to apply a rotation gate having a rotation angle other than the available gate angle settings, the discretised gate having the nearest gate angle setting is applied. The resulting probability distribution 22 is biased, i.e. the mean value is shifted, due to the build-up of a coherent discrepancy due to over- and under-rotations. The scaled mean value 25 of the second probability distribution 22 is approximately 0.12.

The third probability distribution 23 is an experimentally estimated histogram based on the quantum device having 2⁷=128 discretised gates used to determine the second probability distribution 22. The difference in this scenario is that when an instruction is received to apply a rotation gate having a selected rotation other than any of the discrete gate angle settings, three discretised gates are determined based on the selected rotation and applied in accordance with a determined relative frequency to exactly implement the desired rotation angle on average. As can be seen from FIG. 2, this method returns the expected value (Z) 24 of the first probability distribution 21. That is to say, the behaviour of the ideal quantum device (one with infinite resolution) can be replicated using a physical quantum device with finite resolution.

In FIG. 2, the first and third probability distributions 21, 23 have the same expected value [symbol] Z [symbol] 24. However, the third probability distribution 23 has a slightly increased variance relative to the first probability distribution 21. The maximum increase in variance is a factor of e^{vΔ}^{²}^{/4}≈1.03681, i.e. less than a 3.7% increase for v=120 quantum gates.

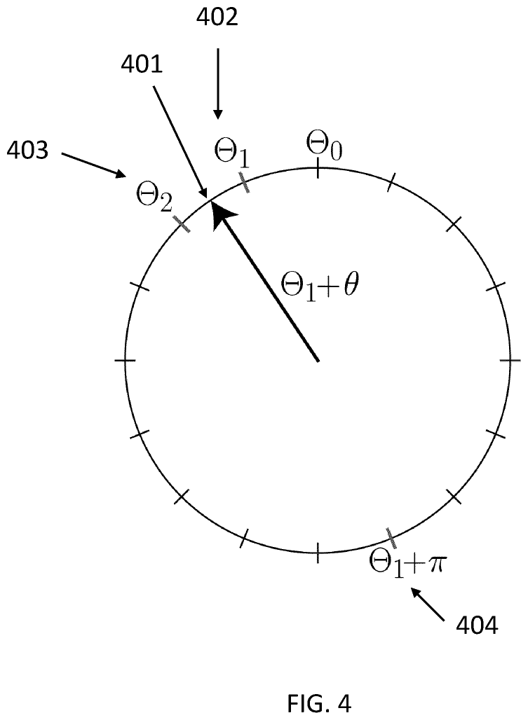

The increased variance of the expected value [symbol] Z [symbol] of an observable in the third probability distribution 23 leads to a circuit-repetition overhead, the value of which is discussed in relation to FIG. 4.

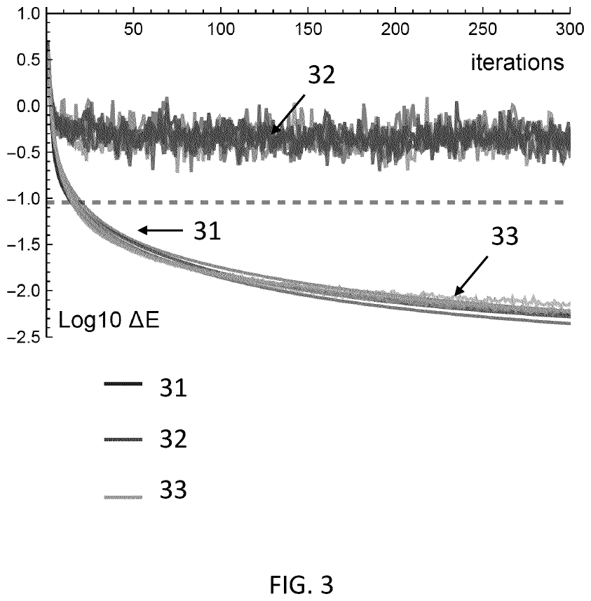

FIG. 3 further illustrates the comparative performance of a theoretical quantum device having infinite resolution; and a quantum device having finite resolution with and without employing the described method, i.e. the probabilistic angle interpolation technique. FIG. 3 shows the energy minimisation for the three scenarios described, specifically the gradient descent minimisation of the energy of a 12-qubit spin-ring problem. This type of problem is a typical application of early quantum computers whereby one aims to determine the quantum state that minimises the energy of a quantum Hamiltonian. Typically, spin problem Hamiltonians are used as these have relevance in fundamental physics and in binary optimisation in commercial applications. The energetic distance, ΔE, from the exact ground-state energy is determined using a circuit having 540 parametrised gates. For such a small-scale, classically-simulatable problem on 12 qubits this is a relatively deep circuit but the number of required parameterised gates might be on the order of thousands for larger problem instances involving more than 50 qubits. In this example, a portion of the 540 parametrised gates are single-qubit gates and a portion of the 540 parametrised gates are two-qubit gates.

The first dataset 31 is theoretically determined. In the first dataset 31, the optimisation assumes a theoretical quantum device having ideal properties: infinite rotation-angle resolution (B→∞) and infinite number of repetitions (Nₛₕₒₜ→∞). The second and third datasets 32, 33 assume a quantum device with finite rotation-angle resolution and finite number of repetitions. For the second and third datasets, there are 2⁷ discretised gates and Nₛₕₒₜ=10⁶ repetitions. In FIG. 3 the parameters of the quantum gates are tuned with the aim of finding a parameter setting that achieves the lowest possible energy. The dashed line shows the lowest possible energy to be achieved with discrete gate angle settings, i.e., with every gate set to its “best” discrete gate angle setting. In the second dataset 32, the gradient vector is calculated at the nearest angular setting. That is, the discretised gate having the discrete gate angle setting closest to the instructed angular rotation is selected and applied to the qubit. The energy is calculated assuming infinite resolution. This informs on the optimiser's progress. In the third dataset 33, the 10⁶ repetitions are formed from 10⁴ repetitions of each of 100 different, randomly chosen circuit configurations. In this example, 540 sets of at least three discretised gates are determined, and corresponding relative frequencies for each set are determined. Some of the sets may have one or more gates in common. Indeed, if the selected rotation angle of one rotation gate is the same as another, the sets and relative frequencies will also be the same. Subsequently, 100 distinct sequences of 540 selected discretised gates, one from each set, are determined. Each of the 100 distinct sequences is applied 10⁴ times for a total of 10⁶ repetitions. In this example, the quantum device is configured to perform the first of the 100 sequences and the first sequence is repeated 10⁴ times before the quantum device is re-configured to perform the second of the 100 sequences which is repeated 10⁴ times, and so on. This can save quantum resources required to re-configure the quantum device, however in another example, the sequences of discretised gates may be performed in any order. The third dataset 33 utilises the same quantum resources as the second dataset 32, however the third dataset 33 substantially recovers the performance of the hypothetical ideal quantum device in the first dataset 31.

Therefore, from FIG. 3 it can be seen that using discretised gates in practical quantum algorithms, as in the second dataset 32, can lead to a significant accumulation of a coherent discrepancy. This is particularly true when the number of discretised gates of the quantum device is low, such as the 2⁷=128 used in this case.

However, by using the angular interpolation method described, the ideal behaviour of a quantum device having infinite angular resolution is achieved using a practical quantum device having finite angular resolution, as shown by the third dataset 33.

The described approach outperforms the simplistic rounding approach which could be employed using a quantum device having finite angular resolution, whilst using the same number of circuit repetitions and the same number of discretised gates.

FIG. 4 is a schematic illustration of the discrete gate angle settings on a Bloch sphere.

Parametrised Pauli gates, as discussed above, encompass most gatesets developed for quantum technologies, including single qubit X, Y or Z rotations or two-qubit XX entangling gates. Pauli gates have the form e^{-iθP}^{ₖ} for any Pauli string Pₖ∈{Id, X, Y, Z}^{⊗N}, wherein N is the number of qubits in the system. When a gate is applied to a qubit, the effect is that the gate maps a density matrix to another density matrix by conjugation with the respective unitary matrix, i.e. [symbol] (θ)ρ: =e^{-iθP}^{ₖ}ρe^{iθP}^{ₖ}, wherein [symbol] (θ) is the super-operator representation of a parametrised Pauli gate and ρ is a density matrix.

A Pauli rotation gate [symbol] (θ) at any continuous rotation angle θ can be decomposed as a linear combination of 4 different gates each having a different discrete rotation angle

$$θ = 0 , \frac{π}{2} , - \frac{π}{2}$$

and π as follows:

$$ℛ ( θ ) = \frac{1 + cos θ}{2} ℛ ( 0 ) + \frac{sin θ}{2} [ ℛ ( \frac{π}{2} ) - ℛ ( - \frac{π}{2} ) ] + \frac{1 - cos θ}{2} ℛ ( π )$$

FIG. 4 illustrates a physical quantum device which can perform a discretised set of parametrised Pauli gates [symbol] (Θₖ), wherein

$${Θ}_{k} = \frac{2 π k}{{2}^{B}} ,$$

k∈{0, 1, . . . 2^{B}−1}, and B is the number of gates in the set. Therefore, as the quantum device has discretised gates, this means that some angular rotations cannot be performed using just one discretised gate. The physical quantum device according to the invention can perform rotation gates in a digitised fashion with a finite resolution of B bits. If the instructed angular rotation 401 lies between two angular rotation settings 402, 403 of the discretised gates, the method described herein can be used to implement a rotation gate having the instructed angular rotation.

The rotation angle to be applied is chosen according to experimental requirements. In this example, the selectable rotation angle 401 may be any rotation angle with unlimited precision and range. In alternative examples, the rotation angle may be selected from a specified range of rotation angles and/or with specified maximum precision.

In this example, the selected rotation angle 401 is between a first discrete gate angle setting 402 and a second discrete gate angle setting 403. The first and second discrete angle settings 402, 403 are adjacent and there are no available discretised gates having angular rotations between the first and second discrete angle settings 402, 403 in the quantum device. The angular separation between the first and second discrete angle settings 402, 403 is A.

The first discrete gate angle setting 402 is Θₖ. The second discrete gate angle setting 403 is Θₖ₊₁=Θₖ+Δ. The chosen angular rotation, i.e. the selected rotation angle 401, is an over-rotation by an angle θ, wherein 0<θ<Δ. This means that in this example, the first and second discrete gate angle settings 402, 403 are the closest discrete gate angle settings to the selected rotation angle 401. The selected rotation angle 401 is Θₖ+θ. The relative position between the two discrete gate angle settings 402, 403 is defined as λ=θ/Δ.

Using the super-operator representation, a first discretised gate is denoted [symbol] (Θₖ) and has the first discrete gate angle setting 402. A second discretised gate is denoted [symbol] (Θₖ₊₁) and has the second discrete gate angle setting 403. A rotation gate is denoted [symbol] (Θₖ+0) and has the selected rotation angle 401. The rotation gate [symbol] (Θₖ+0) can be written as [symbol] (Θₖ) [symbol] (θ) for any over-rotation angle θ.

In a comparative example which also uses a quantum device with discretised gates, upon receipt of an instruction to apply a rotation gate having a selected rotation angle different from the discrete gate angle settings available, the selected rotation angle is simply rounded to the nearest available discrete gate angle setting. Then, the discretised gate having the nearest gate angle setting to the chosen rotation angle is applied to a qubit.

A disadvantage of this comparative example is that by rounding the selected angular rotation value to the nearest available angle, every gate application is an over- or under-rotation when the selected rotation is not the same as one of the available rotations. This can lead to an accumulation of a significant coherent discrepancy in the angular rotation applied. In the worst case, a coherent under- or over-rotation of Δ/2 is incurred, where Δ is the separation between adjacent available angular rotation settings. This leads to a biased probability distribution as shown in FIG. 2. The biased probability distribution has a shifted mean value and therefore would not return an accurate combined output.

In a further comparative example using a quantum device with discretised gates, upon receipt of an instruction to apply a rotation gate having a selected rotation angle Θₖ+θ different from the discrete gate angle settings available, the discretised gates having the two nearest available discrete gate angle settings Θₖ, Θₖ₊₁ would be applied with probabilities λ and 1−λ respectively, wherein λ=θ/Δ is the relative position between the nearest two discrete gate angle settings in the quantum device.

A disadvantage of this comparative example is that on average, a non-unitary operation is obtained. This results in a mixed quantum state, represented as a point contained within the Bloch sphere. Using the method described in this comparative example, a biased incoherent discrepancy on the order of Δ² would be obtained.

In this example, a Pauli rotation gate (as a quantum channel) is expressed as a linear combination of three discretised gates. In addition to the first and second discretised gates having the first and second discrete gate angle settings 402, 403, a third discretised gate having a third discrete gate angle setting 404 is also utilised. The third discretised gate is denoted [symbol] (Θₖ+π). The third discrete gate angle setting 404 in this example is [symbol] ₖ+π; the difference between the first and third discrete gate angle settings 402, 404 is π. In other examples within the scope of this invention, the rotation gate may be expressed as a linear combination of more than three discretised gates. The Pauli rotation gate [symbol] (Θₖ+0) is exactly expressed as follows:

$$ℛ ( {Θ}_{k} + θ ) = {γ}_{1} ( θ ) ℛ ( {Θ}_{k} ) + {γ}_{2} ( θ ) ℛ ( {Θ}_{k + 1} ) + {γ}_{3} ( θ ) ℛ ( {Θ}_{k} + π )$$

wherein [symbol] (Θₖ), [symbol] (Θₖ₊₁), [symbol] (Θₖ+π) are first, second and third discretised gates having discrete gate angle settings of Θₖ, Θₖ₊₁ and Θₖ+π respectively; and γ₁(θ), γ₂(θ) and γ₃(θ) are coefficients. This expression is exact.

The selected rotation angle 401 is Θₖ+θ. As noted above, the rotation gate [symbol] (Θₖ+θ)= [symbol] (Θₖ) [symbol] (θ) for a small angular deviation θ from the k-th discrete gate angle setting Θₖ. This means that only the rotation gate [symbol] (θ) needs to be expanded into a linear combination of rotation gates having different discrete gate angle settings. In this example, the exact, analytic form of the coefficients γₗ:=γₗ(θ) is determined as a function of the over-rotation θ relative to the angular rotation of the first discretised gate, Θₖ, as follows:

$${γ}_{1} = csc ( \frac{Δ}{2} ) cos ( \frac{θ}{2} ) sin ( \frac{Δ}{2} - \frac{θ}{2} )$$

$${γ}_{2} = csc ( Δ ) sin ( θ )$$

$${γ}_{3} = - sec ( \frac{Δ}{2} ) sin ( \frac{θ}{2} ) sin ( \frac{Δ}{2} - \frac{θ}{2} )$$

It is noted that in this example, the first and second coefficients γ₁ and γ₂ are positive and the third coefficient γ₃ is negative. The effect of this is that the sign of the output from the measurement of the qubit following application of the third discretised gate is flipped.

These coefficients γ₁, γ₂, γ₃ are determined by solving the non-linear system of equations set out below. These equations result from the decomposed Pauli rotation gate [symbol] (θ) above.

$${γ}_{1} [ 1 + cos ( 0 ) ] + {γ}_{2} [ 1 + cos ( Δ ) ] + {γ}_{3} [ 1 + cos ( π ) ] = 1 + cos ( θ )$$

$${γ}_{1} sin ( 0 ) + {γ}_{2} sin ( Δ ) + {γ}_{3} sin ( π ) = sin ( θ )$$

$${γ}_{1} [ 1 - cos ( 0 ) ] + {γ}_{2} [ 1 - cos ( Δ ) ] + {γ}_{3} [ 1 - cos ( π ) ] = 1 - cos ( θ )$$

In this example, a relative frequency for selecting each of the at least three determined discretised gates is determined by determining a probability for selecting each of the at least three determined discretised gates. The probabilities for choosing one of the three allowed rotation gates are determined based on the coefficients as pₗ(θ)=|γₗ(θ)|/∥γₗ(θ)∥₁, i.e. the probability of selecting a particular discretised gate is the absolute value of the associated coefficient divided by the norm.

In this example, adjacent discrete gate angle settings are separated by a small, uniform, separation Δ. Accordingly, asymptotic expressions for the coefficients can be written using the relative position λ of the over-rotation θ between two discrete gate angle settings, λ=θ/Δ, as follows:

$${γ}_{1} = ( 1 - λ ) + \frac{λ ( 1 - λ ) ( 1 - 2 λ )}{12} {Δ}^{2} + 𝒪 ( {Δ}^{4} )$$

$${γ}_{2} = λ + \frac{( λ - {λ}^{3} )}{6} {Δ}^{2} + 𝒪 ( {Δ}^{4} )$$

$${γ}_{3} = - \frac{λ ( 1 - λ )}{4} {Δ}^{2} + 𝒪 ( {Δ}^{4} )$$

Therefore, the norm ∥γₗ(θ)∥₁ can be expanded into leading terms to be expressed as

$${‖ {γ}_{l} ( θ ) ‖}_{1} = 1 + \frac{λ - {λ}^{2}}{2} {Δ}^{2} + 𝒪 ( {Δ}^{4} ) .$$

In the worst-case scenario, the selected rotation angle 401 is in the middle of two closest discrete gate angle settings 402, 403, i.e. λ=0.5. In this case, ∥γₗ(Δ/2)∥₁=1+Δ²/8+ [symbol] (Δ⁴).

Accordingly, the first discretised gate [symbol] (Θₖ) having the first discrete gate angle setting 402, Θₖ, is applied with probability p₁(θ)=(1−λ)+ [symbol] (Δ²). The second discretised gate [symbol] (Θₖ₊₁) having the second discrete gate angle setting 403, Θₖ₊₁, is applied with probability p₂(θ)=λ+ [symbol] (Δ²). The third discretised gate [symbol] (Θₖ+π) having the third discrete gate angle setting 404, Θₖ+π, is applied with probability

$${p}_{3} ( θ ) = \frac{1}{4} λ ( 1 - λ ) {Δ}^{2} .$$

By applying the first, second and third discretised gates according to the determined probabilities, the rotation angle is implemented substantially accurately, on average. The application of a gate and subsequent measurement of the state of the qubit is repeated Nₛₕₒₜ times, and a mean value of the individual outcomes is calculated and multiplied by the norm ∥γ(θ)∥₁ to obtain an expected value [symbol] O [symbol] of an observable ∘. The norm ∥γ(θ)∥₁ may also be referred to as the global pre-factor.

In this example, a sampling scheme is defined in which one of the three selected discretised gates is applied to a qubit. To do this, the three rotation operators [symbol] (Θₖ), [symbol] (Θₖ₊₁), [symbol] (Θₖ+π) can be abbreviated as [symbol] ₁:= [symbol] (Θₖ), [symbol] ₂:= [symbol] (Θₖ₊₁), and [symbol] ₃:= [symbol] (Θₖ+π), and the rotation gate having the rotation angle Θₖ+θ can be exactly expressed as follows:

$$ℛ ( {Θ}_{k} + θ ) = {‖ γ ( θ ) ‖}_{1} {\sum }_{l = 1}^{3} {p}_{l} ( θ ) sign [ {γ}_{l} ( θ ) ] {ℛ}_{l}$$

This leads to the definition of a randomised scheme and corresponding estimator of the rotation operator. One of the three rotation gates

$${\{ ℛ \}}_{l = 1}^{3}$$

is randomly selected according to the probability distribution pₗ(θ) and implemented in the quantum device. In this case, the unbiased estimator of the quantum channel is [symbol] (Θₖ+θ)=∥γ(θ)∥₁ sign[γₗ(θ)] [symbol] ₁. Note that using this, the output of the state of the qubit from a measurement is saved multiplied by the sign of the coefficient, sign [γₗ(θ)]. Applying this quantum gate to any quantum state ρ and computing the expected value any operator yields the unbiased estimator as ô=Tr[O [symbol] (Θₖ+θ)ρ] of the expected value [symbol] O [symbol] . This estimator is unbiased based on sampling the first, second and third discretised gates with probabilities pₗ(θ):=|γₗ(θ)|/∥γₗ(θ)∥₁.

In this example, the separation Δ between each of the discrete gate angle settings is the same. However, in an alternative example, the separations between the discrete gate angle settings may be different. When the angle discretisations are not uniform, i.e. the angular separation between adjacent discrete gate angle settings is not the same, then the above equations can be modified by using Δₖ=Θₖ₊₁−Θₖ. The measurement cost can then be upper bounded by using the largest separation Δₘₐₓ.

Application of the third discretised gate with the small probability p₃(θ) avoids introducing an incoherent discrepancy to the state of the qubit. Just using the first and second discretised gates would mix the desired state with an over-rotated state [symbol] (Θₖ+π)[ρ].

When the third discretised gate is applied to a qubit, the sign of every observable measurement output is flipped. That is to say, when the third discretised gate is selected from the determined first, second and third discretised gates, the third discretised gate is applied to a qubit to perform a rotation of Θₖ+π. Following the rotation, the state of the qubit is measured. This returns an output of |0> or |1> which is typically interpreted as a number, e.g., <1|∘|1> or <0|∘|0>, when the aim is to estimate an expected value of O. The sign of this number is flipped because the coefficient associated with the third discretised gate, γ₃, is negative. Therefore, the measurement contributes +1 or −1 to the combined output.

As noted in relation to FIG. 2, the increased variance of the expected value [symbol] O [symbol] of an observable O leads to a circuit-repetition overhead. Using the above equations, the variance is Var[ô]=Var[Tr[O [symbol] (Θₖ+θ) p]]. For Var [ô]= [symbol] [(ô− [symbol] [ô])²], the upper bound of the variance [symbol] [ô²]= [symbol] [Tr[O [symbol] (Θₖ+θ)ρ]²]. Using the above expansion of the rotation gate having the rotation angle Θₖ+θ,

$$𝔼 [ {Tr [ 𝒪 \hat{ℛ} ( {Θ}_{k} + θ ) ρ ]}^{2} ] = {\sum }_{l = 1}^{3} {{p}_{l} ( θ ) [ {‖ γ ( θ ) ‖}_{1} sign [ {γ}_{l} ( θ ) ] Tr [ X {ℛ}_{l} ρ ] ]}^{2} .$$

because Tr[O [symbol] ₗρ]²≤1, the upper bound of the variance is

$$Var [ \hat{o} ] \leq {‖ γ ( θ ) ‖}_{1}^{2} = 1 + λ ( 1 - λ ) {Δ}^{2} + O ( {Δ}^{4} ) .$$

For a quantum device having 2⁷ discretised gates, this overhead is 0.06% at worst.

In an example in which there are a plurality of quantum rotation gates N_{gates} to be performed in sequence in the circuit, the upper bound of the circuit repetition overhead is given as follows:

$$Var [ \hat{o} ] \leq {\prod }_{l = 1}^{v} {‖ {γ}^{( l )} ( {θ}_{l} ) ‖}_{1}^{2} = {[ 1 + \frac{{Δ}^{2}}{4} ]}^{v} + O ( {Δ}^{4} ) \approx {e}^{v {Δ}^{2 / 4}}$$

wherein ∥γ^{(l)}(θₗ)∥₁ is the norm for each rotation gate in the sequence. Each rotation gate has a selectable rotation angle which may be different and may be the same for any two rotation gates in the sequence.

As will be appreciated, a method of implementing a continuous rotation gate using a quantum device with discretised gates is provided. Such a device is low power and low complexity with enhanced capabilities which enable the recovery of the performance of an ideal quantum device having infinite rotation-angle resolution and infinite number of repetitions.

1. A method of implementing a rotation gate having a selectable rotation angle using a quantum device with discretised gates each having a discrete gate angle setting, the method comprising:
(i) receiving an instruction to apply a rotation gate having a selected rotation angle, wherein the selected rotation angle is not the same as any of the discrete gate angle settings;
(ii) determining at least three discretised gates, based on the selected rotation angle, each having different discrete gate angle settings, wherein:
a first discrete gate angle setting is less than the selected rotation angle;
a second discrete gate angle setting is greater than the selected rotation angle; and
a third discrete gate angle setting differs by more than an angle of π/2 with respect to the selected rotation angle;
(iii) determining a relative frequency for selecting each of the at least three determined discretised gates;
(iv) selecting one of the at least three determined discretised gates based on the determined relative frequency;
(v) applying the selected discretised gate to a qubit;
(vi) measuring the state of the qubit to provide an output;
(vii) repeating steps (iv)-(vi) a plurality of times; and
(viii) combining the outputs from step (vi) to obtain a combined output based on the selected discretised gates.

2. The method of claim 1, wherein step (iii) comprises determining a probability for selecting each of the at least three determined discretised gates; and step (iv) comprises selecting one of the at least three determined discretised gates based on the determined probabilities.

3. The method of claim 1, wherein step (iii) comprises: expressing the rotation gate as a linear combination of the determined discretised gates; and determining a coefficient for each of the determined discretised gates in the linear combination, wherein the coefficient for at least one of the determined discretised gates is negative.

4. The method of claim 1, wherein first and second discrete gate angle settings are the closest two discrete gate angle settings to the selected rotation angle.

5. The method of claim 1, wherein the difference between two of the discrete gate angle settings is approximately π radians.

6. The method of claim 1, wherein step (ii) comprises determining three discretised gates, based on the selected rotation angle, each having different discrete gate angle settings.

7. The method of claim 1, wherein step (ii) comprises:
searching a data set for the selected rotation angle, wherein the data set comprises selectable rotation angles and at least three corresponding discretised gates for each selectable rotation angle; and
determining at least three discretised gates based on the at least three discretised gates in the data set corresponding to the selected rotation angle.

8. The method of claim 7, wherein the data set further comprises relative frequencies for selecting each of the at least three discretised gates corresponding to each selectable rotation angle, and wherein step (iii) comprises:
searching the data set for the selected rotation angle; and
determining a relative frequency for selecting each of the at least three determined discretised gates based on the relative frequency in the data set corresponding to the selected rotation angle.

9. The method of claim 1, wherein the method comprises:
(i) receiving an instruction to apply first and second rotation gates having first and second selected rotation angles respectively, wherein the first and second selected rotation angles are not the same as any of the discrete gate angle settings;
(ii)(a) determining a first set of at least three discretised gates, based on the first selected rotation angle, each having different discrete gate angle settings, wherein:
a first first discrete gate angle setting is less than the first selected rotation angle;
a first second discrete gate angle setting is greater than the first selected rotation angle; and
a first third discrete gate angle setting differs by more than an angle of π/2 with respect to the first selected rotation angle;
(ii)(b) determining a second set of at least three discretised gates, based on the second selected rotation angle, each having different discrete gate angle settings, wherein the first set and second set of at least three discretised gates may comprise one or more of the same discretised gates, wherein
a second first discrete gate angle setting is less than the second selected rotation angle;
a second second discrete gate angle setting is greater than the second selected rotation angle; and
a second third discrete gate angle setting differs by more than an angle of π/2 with respect to the second selected rotation angle;
(iii)(a) determining a first relative frequency for selecting each of the at least three determined discretised gates in the first set;
(iii)(b) determining a second relative frequency for selecting each of the at least three determined discretised gates in the second set;
(iv)(a) selecting one of the at least three determined discretised gates from the first set as a first selected discretised gate based on the first determined relative frequency;
(iv)(b) selecting one of the at least three determined discretised gates from the second set as a second selected discretised gate based on the second determined relative frequency;
(v) applying the first and second selected discretised gates to a qubit;
(vi) measuring the state of the qubit to provide an output;
(vii) repeating steps (iv)-(vi) a plurality of times; and
(viii) combining the outputs from step (vi) to obtain a combined output based on the selected discretised gates.

10. The method of claim 9, wherein the first and/or second selected discretised gates are applied to two qubits.

11. The method of claim 1, wherein the discretised gates are determined by a discrete set of possible voltage settings.

12. The method of claim 1, wherein the at least three determined discretised gates are determined from a set of between 3 and 2¹⁸ discretised gates, preferably between 3 and 2¹² discretised gates, more preferably between 3 and 128 discretised gates.
